(19) United States
(12) Patent Application Publication
(10) Pub. No.: US 2013/0237085 A1
(43) Pub. Date: Sep. 12, 2013

(54) USB connector for sensing insertion

(71) Applicants: Hyun-Jun Kim, Daejeon (KR); Dae-Young Youn, Daejeon (KR); Sang-Min Kim, Daejeon (KR); Jin-Hyeok Kim, Daejeon (KR)

(72) Inventors: Hyun-Jun Kim, Daejeon (KR); Dae-Young Youn, Daejeon (KR); Sang-Min Kim, Daejeon (KR); Jin-Hyeok Kim, Daejeon (KR)

(73) Assignee: SMART POWER SOLUTIONS, INC., Daejeon (KR)

(21) Appl. No.: 13/988,314

(22) PCT Filed: Nov. 23, 2011
(86) PCT No.: PCT/KR2011/008967

§ 371 Date: May 17, 2013

(30) Foreign Application Priority Data
Nov. 26, 2010 (KR) 1020100118590

(51) Int. Cl. H01R 13/70

(52) U.S. Cl. CPC H01R 13/70
USPC 439/357

(57) ABSTRACT

Provided is a USB connector capable of sensing the insertion of USB devices such as a mobile phone, PDA, MP3 player and the like into the USB connector. The USB connector includes: a fixing body which is shaped as a quadrangle and made of metal material; an insulating member which is inserted and fixed within the fixing body, and one side of which has a power terminal and a data terminal connected to respective lead pins; and a switching pin which is elastically coupled to one side of the insulating member such that the switching pin is insulated from the fixing body, and which senses the insertion of a USB device by being brought into contact with the USB device inserted into the fixing body.

### TECHNICAL FIELD

The present invention relates to a universal serial bus (USB) connector, and more particularly, to a USB connector for sensing insertion capable of sensing the insertion of USB devices into the USB connector, such as a mobile phone, PDA, MP3 player which are powered through the USB connector.

### BACKGROUND ART

The Universal Serial Bus (USB) interface is the most popular connection fashion recently. The USB connector refers to a terminal, a plug or a connector that is installed in a personal computer, a laptop computer or an adaptor and inserts therein a USB device such as a mobile phone, a personal digital assistant (PDA), a MP3 player, a memory stick for operating power supply or data communication.

As various application programs have been developed, more USB devices such as a printer, a speaker, a mouse, a scanner, an adapt, a mobile phone and an MP3 player need to be connected, than is conventionally required. Nowadays, more convenient and capable USB interfaces are used for connecting the USB devices to a main body. The USB interfaces benefit in that it may easily connect the USB devices and is equipped with a hot plugging capability and an excellent plug and play capability so that a computer need not be re-booted when USB devices are changed.

Typically, the USB connectors are installed at least one of the front, side or rear of the main body of a computer or a communication terminal. However, even when a USB device is not inserted into the USB connector, current is applied to the USB connector due to the operation of a power converter in a power-on or standby state, thereby resulting in unnecessary power consumption of the power converter.

### DISCLOSURE

### Technical Problem

An object of the present invention is to provide a USB connector for sensing insertion capable of sensing the insertion of USB devices into the USB connector, such as a mobile phone, PDA, MP3 player and the like which are powered through the USB connector, based on physical contact.

Objects of the present invention are not limited to the above-mentioned object. Other objects that are not mentioned may be obviously understood by those skilled in the art to which the present invention pertains from the following description.

### Technical Solution

In one general aspect, a USB connector for sensing insertion includes: a fixing body being shaped as a quadrangle and made of metal material; an insulating member which is inserted and fixed within the fixing body, wherein one side of which has a power terminal and a data terminal connected to respective lead pins; and a switching pin which is elastically coupled to one side of the insulating member, wherein the switching pin is insulated from the fixing body and senses the insertion of a USB device by being brought into contact with the USB device inserted into the fixing body.

The switching pin may be extended from the one side of the insulating member toward the inside of the fixing body through a slot of the fixing body, and the switching pin may be bent in the slot of the fixing body.

The switching pin may allow current applied from the outside to flow into the fixing body upon being brought into contact with the USB device, a lead pin corresponding to the switching pin may be connected and fastened through the insulating member, and standby power supplied to the power terminal may be interrupted upon sensing that the USB device is detached through the switching pin.

The USB connector may further include a fixing pin formed on and integrated with at least one of the surfaces of the fixing body, and elastically fixing the USB device inserted therein.

### Advantageous Effects

As set forth above, according to the present invention, the insertion of USB devices such as a mobile phone, a PDA, a MP3 player can be sensed based on physical contact. Further, if a USB device is not inserted into a USB connector, a power converter is not operated even in a power-on or standby state, such that unnecessary power consumption can be prevented.

### DESCRIPTION OF DRAWINGS

The above and other objects, features and advantages of the present invention will become apparent from the following description of preferred embodiments given in conjunction with the accompanying drawings, in which:

FIG. 1 is an exploded perspective view of a USB connector according to an embodiment of the present invention.

FIG. 2 is a perspective view of the USB connector assembly of FIG. 1.

FIG. 3 is a front view of the USB connector of FIG. 2.

FIG. 4 is a diagram conceptually illustrating an application example of a USB connector according to an embodiment of the present invention.

[Detailed Description of Main Elements]

| 100: USB connector | 110: fixing body |
|---|---|
| 120: fixing pin | 115, 130: slot |
| 140: protrusion | 150: insulating member |
| 151: base | 153: rear part |
| 155: pin coupling part | |
| 161~167: power and data terminals | |
| 162~168: lead pins | 170: switching pin |

### BEST MODE

Hereinafter, exemplary embodiments of the present invention will be described in detail with reference to the accompanying drawings. Throughout the drawings, like reference numbers are used to designate like elements. Moreover, detailed descriptions related to well-known functions or configurations will be omitted in order not to unnecessarily obscure the gist of the present invention.

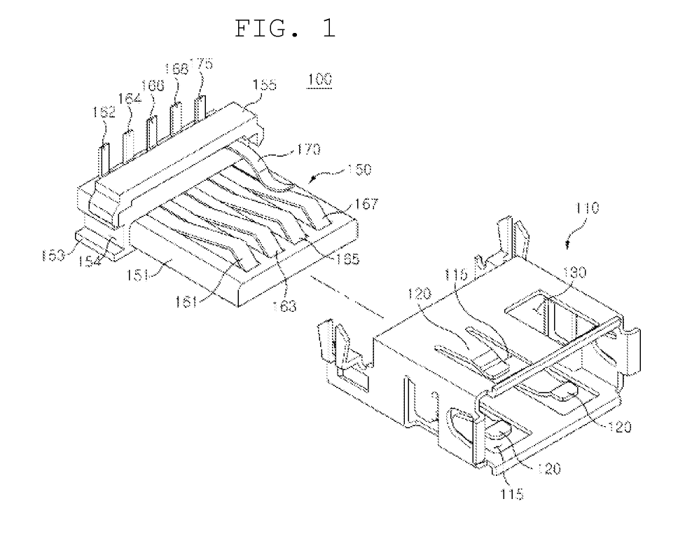

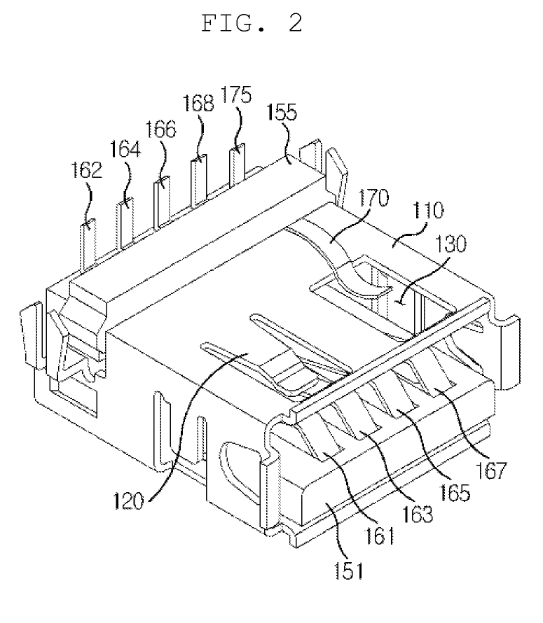

FIG. 1 is an exploded perspective view of a USB connector according to an embodiment of the present invention, and FIG. 2 is a perspective view illustrating the bottom of the USB connector assembly of FIG. 1.

The USB connector 100 includes a fixing body 110, fixing pins 120, an insulating member 150, and a switching pin 170.

The fixing body 110 is shaped generally as a quadrangle and made of conductive material such as metal.

The fixing pins 120 are integrated with at least one of the surfaces of the fixing body 110 so as to elastically fix a USB device (not shown) inserted into the fixing body 110. As shown, the fixing pins 120 are integrated with the fixing body 110 at top and bottom surfaces of the fixing body 110, and are bent inwardly in slots 115 so as to elastically fixing the inserted USB device. In the embodiment, plural spaced-apart fixing pins 120 are formed in the slots 115 at the top surface of the fixing body, and one fixing pin 120 is formed in the slot 115 at the bottom surface of the fixing body 110. At the bottom surface of the fixing body 110, only a slot 130 is formed on the other side.

The insulating member 150 is inserted into and fixed in the fixing body 110, and has power terminals 161 and 167 and data terminals 163 and 165 formed spaced apart on its one side. Each of the terminals 161˜167 is connected to the respective one of the lead pins 162˜168 formed on the other side of the insulating member 150. As shown, the insulating member 150 includes: a base 151, on one surface of which the power terminals 161 and 167 and the data terminals 163 and 165 are disposed spaced apart; a rear part 153 in which lead pins 162˜168 connected to the power terminals 161 and 167 and the data terminals 163 and 165 extending from the base 151 and being bent, and in which a concaved groove 154 are formed at the side thereof to couple with a protrusion 140 of the fixing body 110; and a pin coupling part 155 which extends downwardly at the interface between the base 151 and the rear part 153 and has a switching pin 170 disposed at one side. Typically, in arranging the plurality of terminals 161˜167, the power terminals 161 and 167 (V+, V−) are disposed on the outer side and the data terminals 163 and 165 (D−, D+) are disposed on the inner side.

Here, the switching pin 170 disposed at the pin coupling part 155 is connected to a corresponding lead pin 175 disposed at the rear part 153. That is, the insulating member 150 may be divided into the base 151 inserted into the fixing body 110, a rear part 153 extended from the base 151 and positioned on outer side of the fixing body 110, and a pin coupling part 155 having the switching pin 170. The power terminals 161 and 167 and the data terminals 163 and 165 are disposed on one surface of the base 151 inserted into the fixing body 110, the lead pins 162˜168 are disposed on one side of the rear part 153 positioned on outer side of the fixing body 110 and electrically connected to the respective terminals 161˜167, and the switching pin 170 is disposed at the pin coupling part 155 and electrically connected to the corresponding lead pin 175 disposed at the rear part 153.

The switching pin 170 is extended from one side of the insulating member 150 toward the inside of the fixing body 110 through the slot 130, and, as shown, is bent in the slot 130 like the fixing pin 120. The switching pin 170 faces and is spaced apart from the power terminals 161 and 167 or the data terminals 163 and 165 formed on one surface of the insulating member 150.

The insulating member 150 thus configured is inserted into and fastened in the fixing body 110 such that the protrusion 140 of the fixing body 110 is fitted into the concaved groove 154 of the insulating member 150 so as to tightly couple the fixing body 110 with the insulating member 150. Here, one end of the switching pin 170 is inserted toward the inside of the fixing body 110 through the slot 130 so as to be bought into contact with a surface of a USB device inserted from the outside. Accordingly, the switching pin 170, which is insulated from and elastically coupled with the fixing body 110 at one side of the insulating member 150, may electrically sense the insertion of the USB device by being brought into contact with the USB device inserted into the fixing body 110 based on physical contact to change an electrical signal.

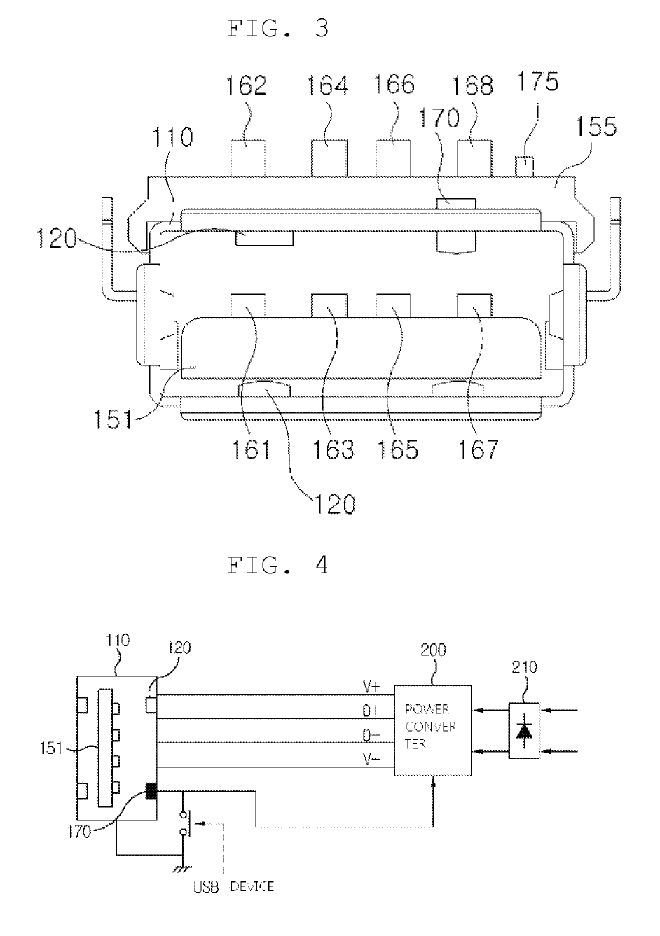

FIG. 3 is a front view of the USB connector of FIG. 2 in which the base 151 of the insulating member 150 is spaced apart from the inner surfaces of the fixing body 110. The distance between the surface of the base 151 on which the terminals 161˜167 are disposed and the inner surface of the fixing body 110 is set to be greater than the distance between the other surface of the base 151 and the inner surfaces of the fixing body 110.

Accordingly, when a USB device is inserted into the fixing body 110 to be brought into contact with the switching pin 170, the current applied from the outside through the switching pin 170 flows into the fixing body 110. Needless to say, when the USB device is detached from the fixing body 110, the switching pin 170 is electrically open, and no current flows.

It is also possible to configure the switching pin 170 to be brought contact with the fixing body 110 when the USB device is inserted. In this configuration, when the USB device is inserted, current directly flows into the fixing body 110 through the switching pin 170, without passing through the USB device. This configuration may be useful when a USB device inserted into a fixing body 110 has no metal frame and only terminals 161˜167 are formed on a plastic base 151.

FIG. 4 is a diagram conceptually illustrating an application example of a USB connector according to an embodiment of the present invention, in which a USB connector 100 and a power converter 200 are shown.

The USB connector 100 may be installed in a such product as a personal computer, a laptop computer and a communication terminal. When powered on or in a standby power mode, the power converter 200 output standby power regardless of whether or not a USB device is connected to power terminals (V+, V−) of a USB connector 100.

The switching pin 170 is electrically connected to an input terminal EN of the power converter 200 so that the power converter 200 may determine if a USB device is attached by sensing change in voltage at the input terminal EN.

If a USB device is detached from the USB connector 100, the switching pin 170 would be in an open (off) state, and thus the input terminal EN of the power converter 200 would maintain a “high” signal. If a USB device is inserted into the USB connector 100, the switching pin 170 would be in a closed (on) state, and thus current applied to the switching pin 170 would flow to ground through the fixing body 110 so that the input terminal of the power converter 200 is pulled down to ground potential GND and changed to a “low” signal.

Accordingly, upon sensing that a USB device is detached with the input terminal EN, the power converter 200 interrupts the power output to the power terminals (V+, V−) of the USB connector 100, such that unnecessary power consumption may be prevented.

The power converter 200 serves to step down a direct current power input through a rectifying circuit unit 210 to a necessary voltage and then supply it to the USB connector 100. The power converter of FIG. 4 is merely an example, and the USB connector according to the present invention may be applied to any device requiring sensing of whether a USB device is detached.

Although the preferred embodiment of the present invention has been disclosed for illustrative purposes, those skilled in the art may conceive other embodiments within the essential scope of the invention. The essential scope of the present invention is defined by the accompanying claims, and technical ideas equivalent thereto are within the scope of the present invention.

1. A USB connector for sensing insertion, the USB connector comprising:
a fixing body being shaped as a quadrangle and made of metal material;
an insulating member which is inserted and fixed within the fixing body, wherein one side of which has a power terminal and a data terminal connected to respective lead pins; and
a switching pin which is elastically coupled to one side of the insulating member, wherein the switching pin is insulated from the fixing body and senses the insertion of a USB device by being brought into contact with the USB device inserted into the fixing body.

2. The USB connector of claim 1, wherein the switching pin is extended from the one side of the insulating member toward the inside of the fixing body through a slot of the fixing body.

3. The USB connector of claim 1, wherein the switching pin is bent in the slot of the fixing body.

4. The USB connector of claim 1, wherein the switching pin allows current applied from the outside to flow into the fixing body upon being brought into contact with the USB device.

5. The USB connector of claim 1, wherein a lead pin corresponding to the switching pin is connected and fastened through the insulating member.

6. The USB connector of claim 1, wherein standby power supplied to the power terminal is interrupted upon sensing that the USB device is detached through the switching pin.

7. The USB connector of claim 1, further comprising a fixing pin formed on and integrated with at least one of surfaces of the fixing body, and elastically fixing the USB device inserted therein.

8. The USB connector of claim 1, wherein the switching pin faces and is spaced apart from the power terminal or the data terminal of the insulating member.

9. The USB connector of claim 1, wherein the switching pin allows current to flow into the fixing body through the USB device if the USB device is inserted.

10. The USB connector of claim 1, wherein the switching pin is configured so that it is brought into contact with the fixing body if the USB device is inserted.
